(19) United States
(12) Patent Application Publication
(10) Pub. No.: US 2017/0090415 A1
(43) Pub. Date: Mar. 30, 2017

(54) ELECTROPHOTOGRAPHIC IMAGE FORMING APPARATUS AND PRINT SHEET CREATION METHOD USING ELECTROPHOTOGRAPHY TECHNOLOGY

(71) Applicant: CASIO COMPUTER CO., LTD., Tokyo (JP)

(72) Inventors: Fumio SHIMAZU, Tokyo (JP); Kazuhiro KAMEYAMA, Tokyo (JP); Shohei OGAWA, Tokyo (JP)

(73) Assignee: CASIO COMPUTER CO., LTD., Tokyo (JP)

(21) Appl. No.: 15/207,433

(22) Filed: Jul. 11, 2016

(30) Foreign Application Priority Data
Sep. 30, 2015 (JP) 2015-194837
Jun. 29, 2016 (JP) 2016-129060

(51) Int. Cl. G03G 15/00; G03G 21/20

(52) U.S. Cl. CPC G03G 21/203

(57) ABSTRACT

An electrophotographic image forming apparatus including an absolute humidity derivation section which derives absolute humidity inside the apparatus, and a control section which, when the absolute humidity inside the apparatus derived by the absolute humidity derivation section is smaller than a predetermined first threshold value, sets a dither pattern density based on an original image to be smaller compared to when the absolute humidity inside the apparatus is larger than the predetermined first threshold value, and forms a latent image on a photosensitive drum.

### CROSS-REFERENCE TO RELATED APPLICATIONS

This application is based upon and claims the benefit of priority from the prior Japanese Patent Applications No. 2015-194837, filed Sep. 30, 2015 and No. 2016-129060, filed Jun. 29, 2016, the entire contents of which are incorporated herein by reference.

### BACKGROUND OF THE INVENTION

1. Field of the Invention

The present invention relates to an electrophotographic image forming apparatus and a print sheet creation method using an electrophotography technology.

2. Description of the Related Art

In an electrophotographic image forming apparatus, the operation of an electrophotographic process (charging, exposure, development, transfer, etc.) is affected by environment such as temperature/humidity. Therefore, the toner density of an image to be formed is not easily kept constant without the environment being adjusted as needed.

Accordingly, a density detection pattern is image-formed on a transfer belt or the like and read by a density sensor, and respective output voltages of a charging device and a developing device, an exposure light quantity output, and the like are adjusted based on a result of the reading so as to correct the toner density.

Japanese Patent Application Laid-Open (Kokai) Publication No. 08-265571, for example, discloses a technique for detecting temperature and humidity inside the apparatus by a temperature and humidity sensor when the toner density is corrected, and adjusting the output voltages and the exposure light quantity output described above to appropriate temperature and humidity values so as to adapt to the environment.

However, depending on the composition, the toner is largely affected by the environment. In cases like this, performing only electrical control adjustment as in Japanese Patent Application Laid-Open (Kokai) Publication No. 08-265571 is not enough. For example, toner for adhesion and welding which is used in the creation of a thermal transfer print sheet (hereinafter referred to as “binder toner”) disclosed in Japanese Patent Application Laid-Open (Kokai) Publication No. 2013-068862 absorbs a large amount of humidity in an environment where absolute humidity is high, which results in a reduced charging characteristic. Accordingly, there is a problem in that, regardless of the way of adjusting electrical control, the transfer ratio of electrostatic toner during development and transfer is low, and as a result the amount of adhesion of the toner is reduced (the toner density is reduced). In addition, there is a problem in that, in a converse environment where absolute humidity is low, the ratio of toner transfer to a photosensitive drum becomes high, and therefore toner in an amount exceeding an estimated amount is developed on the photosensitive drum.

### SUMMARY OF THE INVENTION

An object of the present invention is to deposit a desired amount of toner on a print target medium even if the toner is of a type that is easily affected by environment.

In accordance with one aspect of the present invention, there is provided an electrophotographic image forming apparatus comprising: an absolute humidity derivation section which derives absolute humidity inside the apparatus; and a control section which, when the absolute humidity inside the apparatus derived by the absolute humidity derivation section is smaller than a predetermined first threshold value, sets a dither pattern density based on an original image to be smaller compared to when the absolute humidity inside the apparatus is larger than the predetermined first threshold value, and forms a latent image on a photosensitive drum.

In accordance with another aspect of the present invention, there is provided an electrophotographic image forming apparatus comprising: an absolute humidity derivation section which derives absolute humidity inside the apparatus; and a control section which, when the absolute humidity inside the apparatus derived by the absolute humidity derivation section is larger than a predetermined first threshold value, sets the number of times a toner image is repeatedly transferred to a print target medium such that the number is larger as compared to when the absolute humidity inside the apparatus is smaller than the predetermined first threshold value.

In accordance with another aspect of the present invention, there is provided a print sheet creation method using an electrophotography technology, comprising: an absolute humidity derivation step of deriving absolute humidity inside an apparatus; and a latent image formation step of, when the absolute humidity inside the apparatus derived in the absolute humidity derivation step is smaller than a predetermined first threshold value, setting a dither pattern density based on an original image to be smaller compared to when the absolute humidity inside the apparatus is larger than the predetermined first threshold value, and forming a latent image on a photosensitive drum.

According to the present invention, a desired amount of toner can be deposited on a print target medium even if the toner is of a type that is easily affected by an environment.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a cross-sectional view showing the internal structure of an electrophotographic image forming apparatus 1 according to an embodiment of the present invention;

FIG. 2 is a conceptual diagram showing a positional relationship between a density sensor 40, a temperature and humidity sensor 41, and an intermediate transfer belt 14 in the image forming apparatus 1 and a patch pattern;

FIG. 3 is a flowchart for explaining an operation (patch printing) of the image forming apparatus 1;

FIG. 4 is a conceptual diagram for explaining an excessive toner amount in a low humidity environment;

FIG. 5 is a conceptual diagram for explaining a deficient toner amount in a high humidity environment;

FIG. 6 is a flowchart for explaining an operation (an operation for creating a thermal transfer print sheet) of the image forming apparatus 1;

FIG. 7 is a conceptual diagram for explaining a development/transfer operation in a low humidity environment; and

FIG. 8 is a conceptual diagram for explaining an operation of the image forming apparatus 1.

### DETAILED DESCRIPTION OF THE PREFERRED EMBODIMENT

An embodiment of the present invention will hereinafter be described with reference to the drawings.

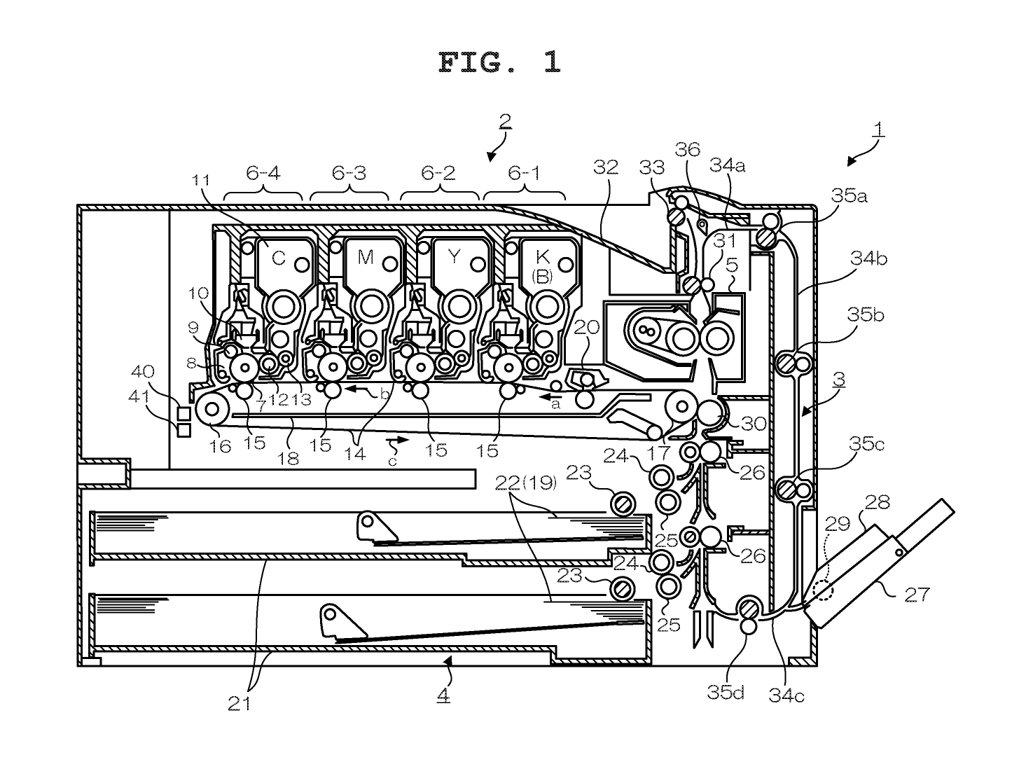

FIG. 1 is a cross-sectional view showing the internal structure of an electrophotographic image forming apparatus 1 according to an embodiment of the present invention. The electrophotographic image forming apparatus 1 of the present embodiment in FIG. 1 has adopted a method of transferring toner images to an intermediate transfer belt 14 and secondarily transferring the toner images to a sheet (print target medium) vertically conveyed to a secondary transfer section via the intermediate transfer belt 14.

This image forming apparatus 1 includes an image forming section 2, a two-sided printing conveyance section 3, a sheet feeding section 4, and a fixing section 5. The image forming section 2 has a structure where four image forming units (developing devices) 6 (6-1, 6-2, 6-3, and 6-4) are provided side by side in multiple stages. The image forming unit 6-1 on the uppermost flow side forms a monochrome image in black (K). The three image forming units 6-2, 6-3, and 6-4 subsequent to the image forming unit 6-1 respectively form monochrome images with color toner in yellow (Y), magenta (M), and cyan (C) serving as the subtractive primary colors. The toner images in the four colors are overlaid on a sheet to form a full-color image.

Also, the image forming unit 6-1 is used to form a binder toner layer by replacing, when wear printing is performed, a toner cartridge in black (K) with a toner cartridge containing binder toner (B). Note that, in the present embodiment, a color image is transferred and fixed onto a sheet (transfer sheet), and then the binder toner layer is formed thereon.

The image forming units 6-1 to 6-4 respectively have the same structures except for the color and the type of the toner contained in the toner cartridge. Therefore, their structures will be described using the structure of the image forming unit 6-4 as an example.

The image forming unit 6 has a photosensitive drum 7 in its lowermost portion. The peripheral surface of this photosensitive drum 7, for example, is formed of an organic photoconductive material. A cleaner 8, a charging roller 9, an optical writing head 10, and a developing roller 12 in a developing device 11 are arranged to come in contact with or around the peripheral surface of the photosensitive drum 7.

The developing device 11 has in its upper portion a toner container containing the toner of one of cyan (C), magenta (M), yellow (Y), and black (K) as indicated by C, M, Y, and K in FIG. 1, or the binder toner (B), and has in its intermediate portion a toner replenishing mechanism oriented downward.

Also, the developing device 11 includes the above-described developing roller 12 in a lateral opening in its lower portion, and has in its inner portion a toner agitating member, a toner supply roller 13 for supplying toner to the developing roller 12, a doctor blade for regulating a toner layer on the developing roller 12 to a predetermined layer thickness, and the like. The optical writing head 10 on the apparatus body side is arranged near the upper surface of the photosensitive drum 7 between the charging roller 9 and the developing device 11.

Also, the intermediate transfer belt 14 is arranged near the lower surface of the photosensitive drum 7. A primary transfer roller 15 is pressed toward the lower surface of the photosensitive drum 7 with this intermediate transfer belt 14 interposed therebetween.

The intermediate transfer belt 14 is an endless-shaped transfer belt constituted by a conductive sheet-like member made of resin containing conductive carbon or an ion conductive material and extending in a flat loop shape substantially from the left end to the right end in FIG. 1 at a substantially center portion of the apparatus body. This intermediate transfer belt 14 is stretched between a driving roller 16 and a driven roller 17, and cyclically driven in the counterclockwise direction in FIG. 1 by the driving roller 16 to cyclically move in the counterclockwise direction indicated by arrows a, b, and c in FIG. 1. Also, a belt cleaner 20 is arranged to come in contact with the surface of the intermediate transfer belt 14. This belt cleaner 20 removes waste toner from the top of the intermediate transfer belt 14.

The photosensitive drum 7 rotates in the clockwise direction in FIG. 1. First, the peripheral surface of the photosensitive drum 7 is initialized by being equally charged by electric charge from the charging roller 9. Then, an electrostatic latent image is formed on the peripheral surface of the photosensitive drum 7 by optical writing from the optical writing head 10 based on printing information.

This electrostatic latent image is changed (developed) to a toner image using the toner contained in the developing device 11 by development processing using the developing roller 12. The toner image, which has been developed on the peripheral surface of the photosensitive drum 7, is directly transferred (primarily transferred) to the belt surface of the intermediate transfer belt 14 by the primary transfer roller 15 along with the rotation of the photosensitive drum 7. The intermediate transfer belt 14 conveys the toner image, which has been directly transferred (primarily transferred) to the belt surface, to a transfer position for a sheet 22 so as to further transfer (secondarily transfer) the toner image to the sheet 22.

A belt position control mechanism 18 in FIG. 1 includes primary transfer rollers 15, each of which is constituted by a conductive foamed sponge that is pressed against the lower peripheral surface of the photosensitive drum 7 with the intermediate transfer belt 14 interposed therebetween. This belt position control mechanism 18 rotationally moves the three primary transfer rollers 15 respectively corresponding to the three image forming units 6-4, 6-3, and 6-2 in cyan (C), magenta (M), and yellow (Y) in the same period with hook-type support shafts as their centers. Also, the belt position control mechanism 18 rotationally moves one primary transfer roller 15 corresponding to the image forming unit 6-1 in black (K) in a rotational movement period different from the period of the three primary transfer rollers 15 so that the intermediate transfer belt 14 comes in contact with or separates from the photosensitive drum 7.

More specifically, the belt position control mechanism 18 switches the position of the intermediate transfer belt 14 to a position for a full-color mode (all the four primary transfer rollers 15 come in contact with the intermediate transfer belt 14), a position for a monochrome mode (only the primary transfer roller 15 corresponding to the image forming unit 6-1 comes in contact with the intermediate transfer belt 14), and a position for a non-transfer mode (all the four primary transfer rollers 15 separate from the intermediate transfer belt 14). Also, at timing at which the binder toner (B) is primarily transferred when a thermal transfer print sheet is created, only the primary transfer roller 15 corresponding to the image forming unit 6-1 also comes in contact with the intermediate transfer belt 14, as in the above-described monochrome mode.

The sheet feeding section 4 includes two sheet cassettes 21 arranged in two upper and lower stages, and a large number of cut sheets 22 are stored in one or both of the sheet cassettes 21 in the sheet feeding section 4. Note that, in the case where a thermal transfer print sheet is created, the sheet 22 is replaced with a transfer sheet (or release sheet) 19. A paper extraction roller 23, a feed roller 24, a separation roller 25, and a standby conveyance roller pair 26 are arranged near each of the sheet feed ports (on the right side in FIG. 1) of the two sheet cassettes 21.

The sheets 22 are conveyed from the sheet cassette 21 one by one by the rotation of the paper extraction roller 23, and are fed to the standby conveyance roller pair 26 via the feed roller 24 and the separation roller 25. Alternatively, when the sheet 22 has an unusual thickness or size, the sheet 22 (or the transfer sheet 19) is fed to the standby conveyance roller pair 26 via a sheet feeding roller 29 from above an MPF (Multi Paper Feeder) tray 28 mounted on an opened mounting section 27.

A secondary transfer roller 30 in FIG. 1, which comes in pressure contact with the driven roller 17 with the intermediate transfer belt 14 interposed therebetween, is arranged in the paper conveyance direction (in the vertically upward direction in FIG. 1) of the standby conveyance roller pair 26. The intermediate transfer belt 14, the driven roller 17, and the secondary transfer roller 30 form a secondary transfer section for the sheet 22 (or transfer sheet 19).

The fixing section 5 including a belt-type thermal fixing unit is arranged on the lower flow side (on the upper side in FIG. 1) of this secondary transfer section. A conveyance roller pair 31 which conveys the sheet 22 (or the transfer sheet 19) after fixing from the fixing section 5, and a paper ejection roller pair 33 which ejects the conveyed sheet 22 to a paper ejection tray 32 formed on the upper surface of the apparatus are arranged on the further lower flow side of the fixing section 5.

The two-sided printing conveyance unit 3 includes a return path (a corridor loop path) branched in the right lateral direction in FIG. 1 from a conveyance path in an intermediate portion between the conveyance roller pair 31 and the paper ejection roller pair 33. This return path includes a start return path 34a, an intermediate return path 34b bent downward, an end return path 34c bent in the left lateral direction for finally reversing a returned sheet, and four return roller pairs 35a, 35b, 35c, and 35d arranged halfway in the return paths. An outlet of the end return path 340 connects to a conveyance path directed toward the standby conveyance roller pair 26 corresponding to the sheet cassette 21 in a lower portion of the sheet feeding section 4.

Also, the two-sided printing conveyance unit 3 is used to not only perform two-sided printing but also perform multiple printing on the respective same surfaces of the sheets 22 (or the transfer sheets 19). Particularly, in the present embodiment, in a case where a thermal transfer print sheet is created, the sheet 22 (or the transfer sheet 19) color-printed in cyan (C), magenta (M), and yellow (Y) is first returned to the secondary transfer section (the driven roller 17 and the secondary transfer roller 30) again via the return path in the two-sided printing conveyance unit 3. Accordingly, a route change flapper 36 is arranged near an inlet of the return path branched in the right lateral direction in FIG. 1 from the conveyance path in the intermediate portion between the conveyance roller pair 31 and the paper ejection roller pair 33. The route change flapper 36 is driven leftward or rightward in FIG. 1 near the inlet of the return path so as to sort the transfer sheet 19 conveyed from the fixing section 5 depending on whether the transfer sheet 19 is directly ejected, is conveyed in a paper ejection direction toward the paper ejection tray 32 to change a print surface, or is fed into the return path to repeatedly perform printing.

Also, on the lower flow side of the image forming unit 6-4 and near the intermediate transfer belt 14, a density sensor 40 is arranged. This density sensor 40 is provided opposing the front surface of the intermediate transfer belt 14, and measures the density of a patch pattern (a density detection pattern with the binder toner (B)) formed on the outer peripheral surface of the intermediate transfer belt 14 (hereinafter referred to as “patch density”) at predetermined timing. Also, a temperature and humidity sensor 41 is similarly arranged on the lower flow side of the image forming unit 6-4 and near the intermediate transfer belt 14. This temperature and humidity sensor 41 measures temperature and humidity (relative humidity) inside the image forming apparatus 1 at predetermined timing. Based on the temperature and the humidity measured by the temperature and humidity sensor 41, absolute humidity inside the image forming apparatus 1 can be derived.

Note that an absolute humidity sensor, which outputs absolute humidity as a measurement result, may be loaded in place of the temperature and humidity sensor 41 which outputs temperature and humidity as a measurement result. In either case, absolute humidity is derivable.

The image forming apparatus 1 controls the frequency of adjustment of a density (dither pattern density) in the binder toner (B) and the degree of the adjustment based on the measurement results (the density and the absolute humidity).

Note that the above-described image forming apparatus 1 includes a CPU (Central Processing Unit) not shown, and controls the operation of each of the above-described sections by executing a predetermined program so as to actualize a predetermined function.

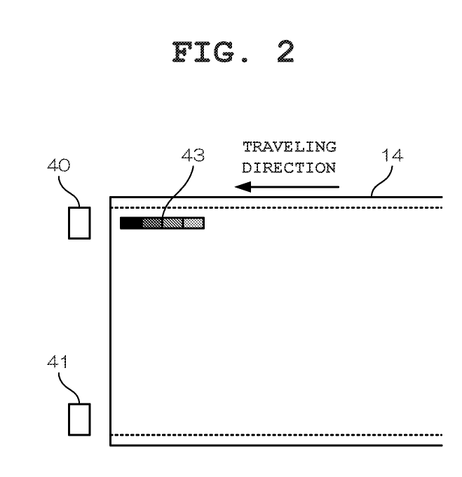

FIG. 2 is a conceptual diagram showing a positional relationship between the density sensor 40, the temperature and humidity sensor 41, and the intermediate transfer belt 14 in the image forming apparatus 1 according to the present embodiment and a patch pattern 43. The patch pattern 43 using the binder toner (B) is formed at predetermined timing on the outer peripheral surface of the intermediate transfer belt 14. Although the patch pattern 43 is basically formed at predetermined time intervals (e.g., every three hours, every six hours, or the like) or immediately before the start of a print job, the present invention is not limited thereto. For example, the patch pattern 43 is formed at timing based on temperature and humidity measured by the above-described temperature and humidity sensor 41, that is, timing depending on the environment. Examples thereof include a case where absolute humidity is equal to or more than a predetermined threshold value, a case where a difference between absolute humidity and the previous absolute humidity is equal to or more than a predetermined threshold value, and a case where the present environment is expected to change to a low-humidity environment (e.g., absolute humidity is less than 20%) or a high-humidity environment (e.g., absolute humidity is 60% or more) after the elapse of several hours from the start of the temporal change of absolute humidity.

The image forming apparatus 1 controls, when the patch pattern 43 is formed, a dither pattern density (the density of a dither pattern) on the photosensitive drum 7 in the binder toner (B) or the number of times of transfer of the binder toner (B) (i.e., the number of layers to be laminated, which is hereinafter referred to as “the number of repetitions) based on the patch density and the absolute humidity at that time. More specifically, if the image forming apparatus 1 is estimated to be in a low-humidity environment (e.g., the absolute humidity is less than 20%) or to enter a low-humidity environment several hours later, a dither pattern density for a latent image on the photosensitive drum 7 in the binder toner (B) is reduced based on the patch density and the absolute humidity at that time. On the other hand, if the image forming apparatus 1 is estimated to be in a high-humidity environment (e.g., the absolute humidity is 60% or more) or to enter a high-humidity environment several hours later, the number of repetitions n (n>1) of the binder toner (B) is set based on the patch density and the absolute humidity at that time. When a print job including image data serving as an original image is generated, the image forming apparatus 1 performs the formation of a latent image on the photosensitive drum 7 with the binder toner (B), primary transfer to the intermediate transfer belt 14, and secondary transfer to the transfer sheet 19 based on the above-described dither pattern density and number of repetitions n. More specifically, in the present embodiment, a dither pattern density (the density of the dither pattern) based on an original image is corrected based on absolute humidity, or the number of times of transfer at a dither pattern density (the density of the dither pattern) based on an original image is switched based on absolute humidity.

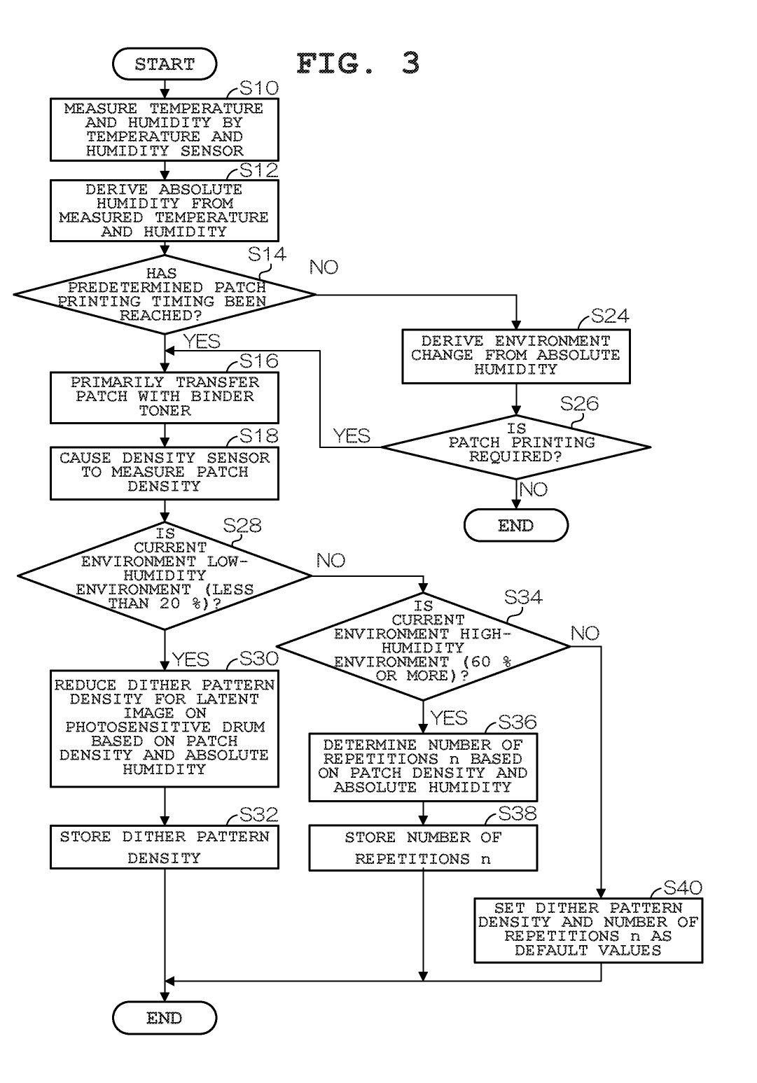

FIG. 3 is a flowchart for explaining an operation (patch printing) of the image forming apparatus 1 according to the present embodiment. Note that the flowchart is executed at time intervals (e.g., intervals of several minutes or several ten minutes) shorter than predetermined patch printing timing (every three hours, every six hours, or immediately before the start of a print job).

First, the image forming apparatus 1 measures temperature and humidity inside the apparatus by the temperature and humidity sensor 41 (Step S10), and derives absolute humidity from the measured temperature and humidity (Step S12).

Then, the image forming apparatus 1 judges whether predetermined patch printing timing has been reached (Step S14). The predetermined patch printing timing described herein corresponds to predetermined time intervals (e.g., every three hours, every six hours, etc.) or timing immediately before the start of a print job as described above.

When the predetermined patch printing timing has been reached (YES at Step S14), the image forming apparatus 1 primarily transfers a patch to the outer peripheral surface of the intermediate transfer belt 14 using the binder toner (B) at a currently set dither pattern density (Step S16), and causes the density sensor 40 to measure the patch density (Step S18).

Then, the image forming apparatus 1 judges whether the current environment is a low-humidity environment (e.g., less than 20%) based on the derived absolute humidity (Step S28). When the current environment is a low-humidity environment (YES at Step S28), the image forming apparatus 1 reduces a dither pattern density for a latent image on the photosensitive drum 7 in the binder toner (B) based on the patch density and the absolute humidity (Step S30), and stores the dither pattern density (Step S32).

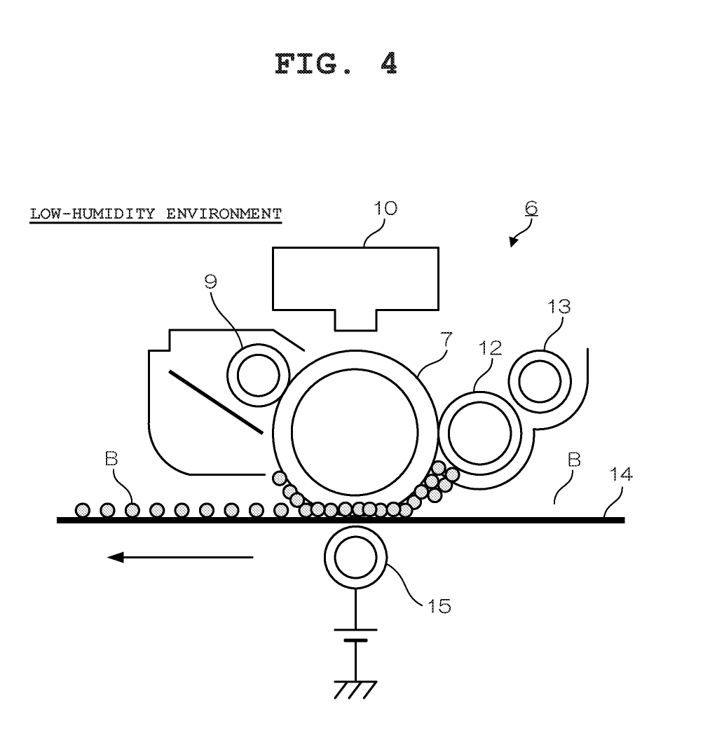

FIG. 4 is a conceptual diagram for explaining an excessive toner amount in a low humidity environment. Note that sections corresponding to those shown in FIG. 1 are provided with the same reference numerals, and therefore descriptions thereof are omitted. As shown in FIG. 4, in a low humidity environment, the ratio of toner transfer to the photosensitive drum 7 becomes high, whereby toner in an amount exceeding an estimated amount is developed on the photosensitive drum 7. In this case, a dither pattern density for a latent image on the photosensitive drum 7 in the binder toner (B) is reduced so as to ensure a desired amount of adhesion.

On the other hand, when the current environment is not a low-humidity environment (e.g., less than 20%) (NO at Step S28), the image forming apparatus 1 judges whether the current environment is a high-humidity environment (e.g., 60% or more) based on the derived absolute humidity (Step S34). When the current environment is a high-humidity environment (YES at Step S34), the image forming apparatus 1 determines the number of repetitions n of the binder toner (B) based on the patch density and the absolute humidity (Step S36), and stores the number of repetitions n (Step S38).

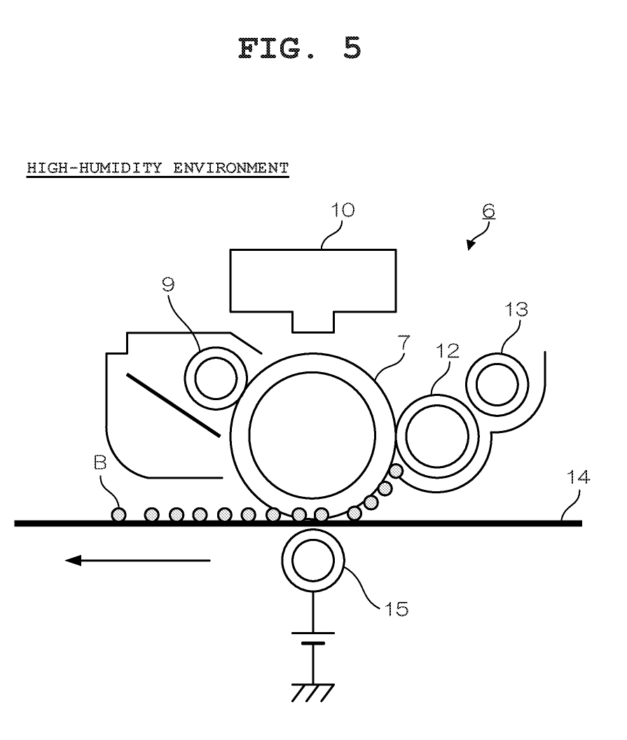

FIG. 5 is a conceptual diagram for explaining a deficient toner amount in a high humidity environment. Note that sections corresponding to those shown in FIG. 1 are provided with the same reference numerals, and therefore descriptions thereof are omitted. As shown in FIG. 5, in a high-humidity environment, the binder toner (B) absorbs a large amount of humidity. Therefore, the charging characteristic is reduced, whereby the transfer ratio of electrostatic toner in the case of development on the photosensitive drum 7 and primary transfer to the intermediate transfer belt 14 becomes low. As a result, the amount of adhesion is reduced (the toner density is reduced). In this case, by the development and the transfer of the binder toner (B) being performed more than once, the binder toner (B) is overlaid and laminated, so that a desired amount of adhesion is ensured.

On the other hand, when the current environment is neither a low-humidity environment (e.g., less than 20%) nor a high-humidity environment (e.g., 60% or more) (NO at Step S28 and NO at Step S34), the image forming apparatus 1 sets the dither pattern density and the number of repetitions n as default values (Step S40).

At Step S14, when the predetermined patch printing timing has not been reached (NO at Step S14), the image forming apparatus 1 derives (monitors) an environment change from the absolute humidity (Step S24). The environment change described herein means that the current environment is clearly a low-humidity environment (e.g., the absolute humidity is less than 20%) or a high humidity environment (e.g., the absolute humidity is 60 t or more), a change of the absolute humidity from the previous measurement time is not less than a predetermined threshold value, or that the current environment is expected to become a low-humidity environment or a high-humidity environment several hours later based on the change history of the absolute humidity.

Then, the image forming apparatus 1 judges whether patch printing (density correction) has been required because the above-described environment change has occurred (Step S26). When the patch printing (density correction) is required because the above-described environment change has occurred (YES at Step S26), the above-described Step S28 and the subsequent steps are executed.

More specifically, if the current environment is a low-humidity environment (YES at Step S28), the image forming apparatus 1 reduces the dither pattern density for the latent image on the photosensitive drum 7 in the binder toner (B) based on the patch density and the absolute humidity (Step S30), and stores the dither pattern density (Step S32). Conversely, when the current environment is a high-humidity environment (YES at Step S34), the image forming apparatus 1 determines the number of repetitions n of the binder toner (B) based on the patch density and the absolute humidity (Step S36), and stores the number of repetitions n (Step S38).

When the current environment is neither a low-humidity environment (e.g., less than 20 t) nor a high-humidity environment (e.g., 60% or more) (NO at Step S28 and NO at Step S34), the image forming apparatus 1 sets the dither pattern density in the binder toner (B) and the number of repetitions n of the binder toner (B) as default values (Step S40).

As such, in the present embodiment, in addition to setting a dither pattern density in the binder toner (B) or the number of repetitions n of the binder toner (B) based on respective measurement results of the density sensor 40 and the temperature and humidity sensor 41 at predetermined patch printing timing, the image forming apparatus 1 primarily transfers a patch (Step S16), causes the density sensor 40 to measure the patch density (Step S18) at timing other than the predetermined patch printing timing, and reduces the dither pattern density in the binder toner (B) (Step S30) if the current environment is a low-humidity environment, or determines the number of repetitions n of the binder toner (B) if the current environment is a high humidity environment (Step S36).

As a result of this configuration, toner can be deposited on a print target medium at a more appropriate density (in a desired amount) even if the toner is of a type that is easily affected by environment.

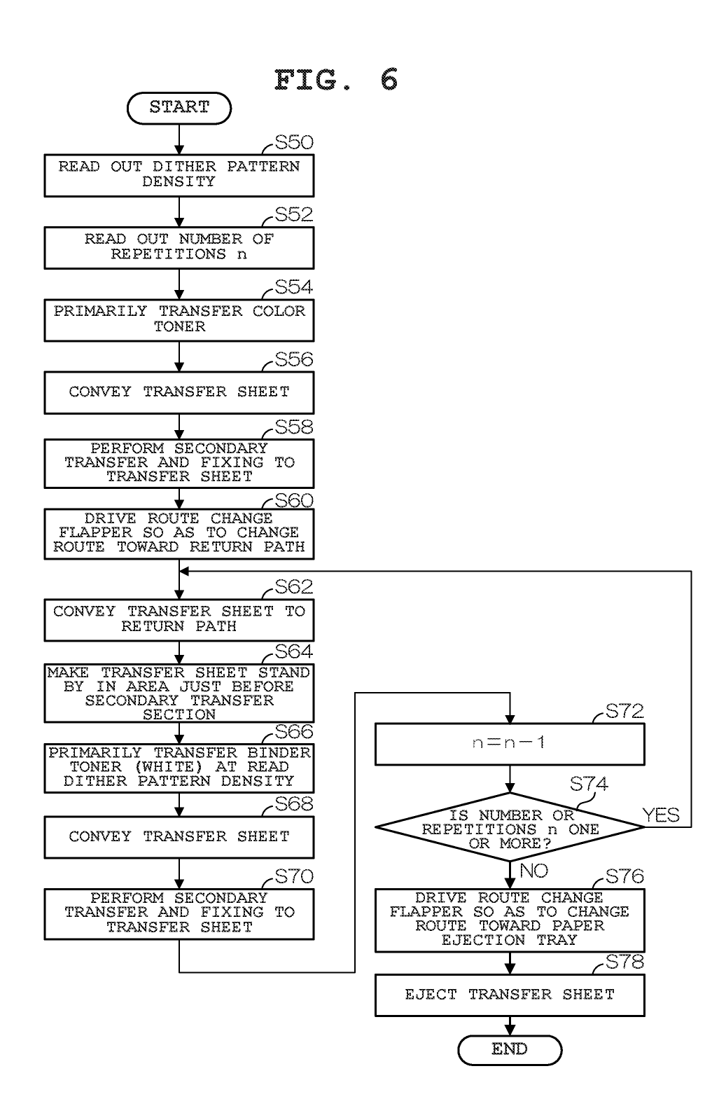

FIG. 6 is a flowchart for explaining an operation (an operation for creating a thermal transfer print sheet) of the image forming apparatus 1 according to the present embodiment. This flowchart is executed when a printing request is made from a host computer, an operation panel, or the like. The image forming apparatus 1 reads out a dither pattern density stored in a memory or the like when a printing request is made (Step S50), and similarly reads out the number of repetitions n (Step S52). Then, the image forming apparatus 1 primarily transfers an image using color toner to the intermediate transfer belt 14 (Step S54). More specifically, in the image forming units 6-2 to 6-4, the photosensitive drum 7 is charged by the charging roller 9, a latent image is formed by the optical writing head 10, toner development is preformed on the photosensitive drum 7, and a toner image is transferred to the intermediate transfer belt 14 by the primary transfer roller 15.

On the other hand, the image forming apparatus 1 conveys the transfer sheet 19 by the rotation of the paper extraction roller 23 from the sheet cassette 21, for example, and feeds the conveyed transfer sheet 19 to the standby conveyance roller pair 26 via the feed roller 24 and the separation roller 25 so as to make the transfer sheet 19 stand by (Step S56). Then, the image forming apparatus 1 feeds the transfer sheet 19, which has been made to stand by at a position of the standby conveyance roller pair 26, into the secondary transfer section (the driven roller 17 and the secondary transfer roller 30) at timing at which the toner image transferred to the intermediate transfer belt 14 reaches the secondary transfer section, secondarily transfers a color image to the transfer sheet 19, and then causes the fixing section 5 to fix the color image (Step S58). The intermediate transfer belt 14 after the transfer is cleaned by the belt cleaner 20.

Then, the image forming apparatus 1 drives a route change flapper 36 to change the route toward the return path (Step S60), and conveys the transfer sheet 19 on which the color image has been fixed to the return path (Step S62). Then, the image forming apparatus 1 feeds the transfer sheet 19 conveyed to the return path to the standby conveyance roller pair 26 via the start return path 34a, the intermediate return path 34b, and the end return path 34c so as to make the transfer sheet 19 stand by (Step S64).

Then, the image forming apparatus 1 primarily transfers a binder layer with the binder toner (B) to the intermediate transfer belt 14 (Step S66). More specifically, in the image forming unit 6-1, the photosensitive drum 7 is charged by the charging roller 9, a latent image is formed by the optical writing head 10 after correcting a dither pattern density based on the original image into a read dither pattern density, the latent image is developed on the photosensitive drum 7 with the binder toner (B), and the toner image with the binder toner (B) is transferred to the intermediate transfer belt 14 by the primary transfer roller 15.

The image forming apparatus 1 feeds the transfer sheet 19, which has been made to stand by at a position of the standby conveyance roller pair 26 and to which the color image has already been fixed, into the secondary transfer section (the driven roller 17 and the secondary transfer roller 30) at timing at which the toner image with the binder toner (B) transferred onto the intermediate transfer belt 14 reaches the secondary transfer section (Step S68), secondarily transfers the binder toner (B) onto a surface of the transfer sheet 19 to which the color image has been fixed, and then causes the fixing section 5 to fix the binder toner (B) (Step S70). The intermediate transfer belt 14 after the transfer is cleaned by the belt cleaner 20, whereby the first cycle of the process for forming a binder toner layer is ended.

Then, the image forming apparatus 1 decrements the number of repetitions n by one (Step S72), and judges whether the number of repetitions n is one or more, that is, whether the secondary transfer and fixing of the binder toner (B) has been performed the number of times corresponding to the number of repetitions n (Step S74). When the number of repetitions n is one or more (YES at Step S74), the image forming apparatus 1 returns to Step S62. At Step S62, the above-described operation is repeated. More specifically, the transfer sheet 19 to which the color image and the layer of the binder toner (B) have been fixed is conveyed to the return path with the route change flapper 36 being directed toward the return path, and the secondary transfer and fixing of the binder toner (B) is performed again the number of times corresponding to the number of repetitions n.

On the other hand, When the number of repetitions n reaches zero (YES at Step S74), the image forming apparatus 1 drives the route change flapper 36 so as to change the route toward the paper ejection tray 32 (Step S76), and ejects the transfer sheet 19 on which the color image and the layer of the binder toner (B) have been formed and which is conveyed from the fixing section 5 to the paper ejection tray 32 (Step S78).

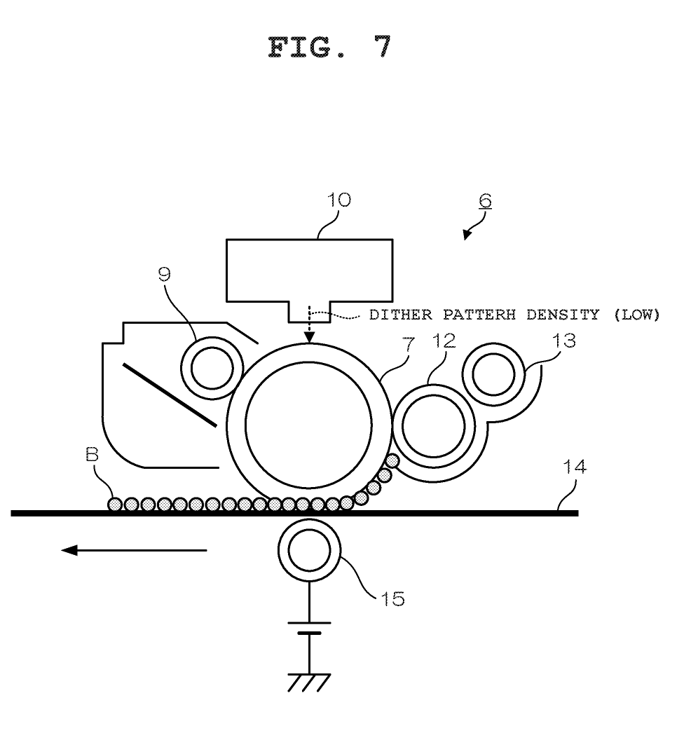

FIG. 7 is a conceptual diagram for explaining a development and transfer operation in a low-humidity environment in the present embodiment. In a low-humidity environment (the absolute humidity is less than 20%), a dither pattern density reduced based on a patch density and absolute humidity has been stored. In this case, the number of repetitions n remains at one (a default value). Accordingly, in the case of a low-humidity environment, a latent image is formed on the photosensitive drum 7 at a dither pattern density whose value has been reduced based on a patch density and absolute humidity at Step S66, so that the amount of adhesion of the binder toner (B) to be developed and transferred becomes a desired amount.

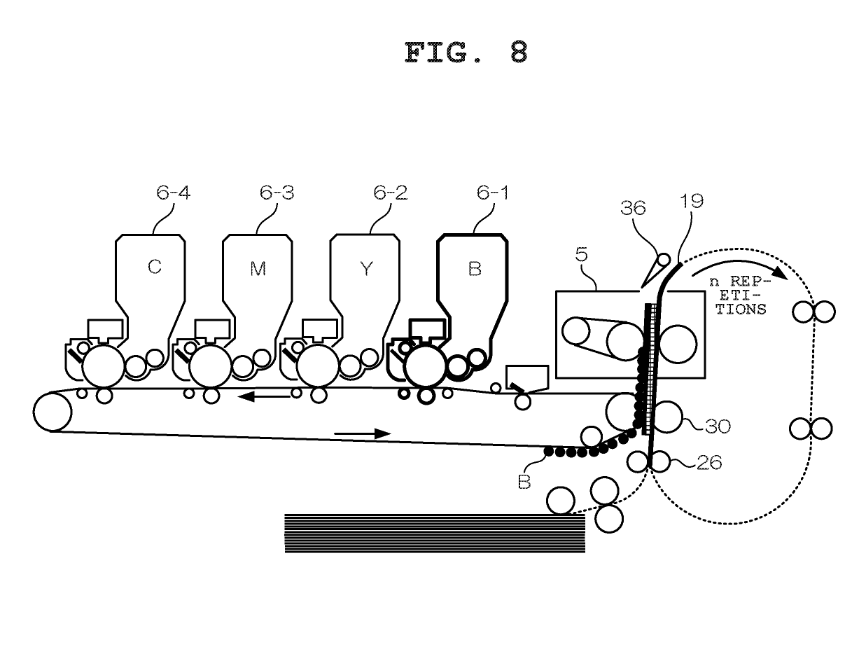

FIG. 8 is a conceptual diagram for explaining a development and transfer operation in a high-humidity environment in the present embodiment. In a high-humidity environment (the absolute humidity is 60% or more), the number of repetitions n of the binder toner (B) derived based on a patch density and absolute humidity has been stored. In this case, the dither pattern density remains at a default value. Accordingly, in the case of a high-humidity environment, a latent image is formed on the photosensitive drum 7 at a normal dither pattern density at Step S66. However, because the binder toner (B) is overlaid and formed by the number of repetitions n from Step S62 to Step S74, the amount of adhesion of the binder toner (B) eventually becomes a desired amount.

According to the above-described embodiment, the dither pattern density of an original image for a latent image formed on the photosensitive drum 7 is lowered as absolute humidity in the environment (inside the apparatus) lowers. As a result of this configuration, a desired amount of toner can be deposited on a print target medium even if the toner is of a type that is easily affected by environment.

Also, according to the above-described embodiment, the density of a density detection pattern formed on the intermediate transfer belt 14 is detected by the density sensor 40, and a dither pattern density is derived based on the density of the density detection pattern and absolute humidity in the environment (inside the apparatus). As a result of this configuration, the desired amount of toner can be more accurately deposited on a print target medium even if the toner is of a type that is easily affected by environment.

Moreover, according to the above-described embodiment, the image forming apparatus 1 judges whether an environment change corresponding to a value equal to or more than a predetermined threshold value has occurred based on absolute humidity in the environment (inside the apparatus), and shortens intervals at which the formation of a density detection pattern and the detection of the density of the density detection pattern by the density sensor 40 are performed, when judged that an environment change corresponding to a value equal to or more than the predetermined threshold value has occurred. As a result of this configuration, environment changes can be easily addressed.

Furthermore, according to the above-described embodiment, the transfer and fixing of toner to the same surface of a print target medium are repeated in proportion to the increase of absolute humidity in the environment (inside the apparatus). As a result of this configuration, a desired amount of toner can be deposited on a print target medium even if the toner is of a type that is easily affected by environment.

Still further, according to the above-described embodiment, the density of a density detection pattern formed on the intermediate transfer belt 14 is detected by the density sensor 40, and the number of repetitions of transfer and fixing of toner to the same surface of a print target medium is derived based on the density of the density detection pattern and absolute humidity in the environment (inside the apparatus). As a result of this configuration, a desired amount of toner can be more accurately deposited on a print target medium even if the toner is of a type that is easily affected by environment.

Yet still further, according to the above-described embodiment, by a print target medium where toner has been secondarily transferred being conveyed to the secondary transfer position again by the route change flapper 36, the toner is secondarily transferred to the same print target medium a plurality of times. As a result of this configuration, the transfer and the fixing of the binder toner (B) can be repeated a plurality of times with a simple structure.

Yet still further, according to the above-described embodiment, the transfer sheet 19 is returned to a position just ahead of the secondary transfer section via the return path by the route change flapper 36. As a result of this configuration, the binder toner (B) can be repeatedly transferred and fixed a plurality of times with a simple structure.

In the above-described embodiment, absolute humidity is less than 20% in a low-humidity environment and is 60% or more in a high-humidity environment. However, whether a current environment is a low-humidity environment or a high-humidity environment may be determined based on a compositional difference of the binder toner (B). Also, in some cases, a low-humidity environment range and a high-humidity environment range overlap with each other depending on the composition of the binder toner (B). In such a case, in a range where the environment ranges overlap each other, whether a dither pattern density is reduced or/and whether development and fixing are repeatedly performed a plural times may be determined depending on the composition of the binder toner (B).

Also, in the above-described embodiment, the temperature and humidity sensor 41 is arranged near the intermediate transfer belt 14 on the lower flow side of the image forming unit 6-4. However, the temperature and humidity sensor 41 may be arranged at another position. Particularly, the temperature and humidity sensor 41 may be arranged near the image forming unit 6-1 containing the binder toner (B) that is easily affected by environmental change.

Moreover, in the above-described embodiment, the density sensor 40 detects the density of a patch pattern on the intermediate transfer belt 14. However, the density sensor 40 may be arranged near the photosensitive drum 7 and detect the density of a patch pattern developed on the surface of the photosensitive drum 7

Furthermore, in the above-described embodiment, the temperature and humidity sensor 41 is arranged outside the developing device 11 containing toner, and control is performed based on the tendency of the density of toner to be developed according to the characteristic of the toner with respect to temperature and humidity outside the developing device 11. However, a configuration may be adopted in which control is performed taking into consideration a time difference until temperature and humidity actually affect toner in the developing device 11. Alternatively, a configuration may be adopted in which control is performed by the temperature and humidity sensor 41 being arranged inside the developing device 11 and the temperature and the humidity of actually contained toner being measured.

Still further, in the above-described embodiment, a contact mono-component developing device has been adopted as the developing device 11. However, as a matter of course, a magnetic brush two-component developing device may be used to perform similar development.

That is, the electrophotographic image forming apparatus according to the present embodiment can be said to include an absolute humidity derivation section which derives absolute humidity inside the apparatus, and a control section which, when the absolute humidity inside the apparatus derived by the absolute humidity derivation section is smaller than a threshold value for dither pattern density, sets the density of a dither pattern based on an original image to be smaller compared to when the absolute humidity inside the apparatus is larger than the threshold value for dither pattern density, and forms a latent image on a photosensitive drum.

Also, the electrophotographic image forming apparatus according to the present embodiment can be said to include an absolute humidity derivation section which derives absolute humidity inside the apparatus, and a control section which, when the absolute humidity inside the apparatus derived by the absolute humidity derivation section is larger than a threshold value for the number of times of transfer, sets the number of times a toner image is repeatedly transferred to a print target medium such that it is larger compared to when the absolute humidity inside the apparatus is smaller than the threshold value for the number of times of transfer.

While the present invention has been described with reference to the preferred embodiment, it is intended that the invention be not limited by any of the details of the description therein but includes all the embodiments which fall within the scope of the appended claims.

What is claimed is:

1. An electrophotographic image forming apparatus comprising:
an absolute humidity derivation section which derives absolute humidity inside the apparatus; and
a control section which, when the absolute humidity inside the apparatus derived by the absolute humidity derivation section is smaller than a predetermined first threshold value, sets a dither pattern density based on an original image to be smaller compared to when the absolute humidity inside the apparatus is larger than the predetermined first threshold value, and forms a latent image on a photosensitive drum.

2. The electrophotographic image forming apparatus according to claim 1, further comprising:
a temperature and humidity sensor which measures temperature and humidity inside the apparatus,
wherein the absolute humidity derivation section derives the absolute humidity based on the temperature and the humidity measured by the temperature and humidity sensor.

3. The electrophotographic image forming apparatus according to claim 1, further comprising:
a pattern formation section which image-forms a density detection pattern on a transfer belt; and
a density sensor which measures a density of the density detection pattern image-formed by the pattern formation section,
wherein the control section sets the dither pattern density based on the density of the density detection pattern measured by the density sensor.

4. The electrophotographic image forming apparatus according to claim 3, wherein the pattern formation section changes time intervals at which the density detection pattern is image-formed each time the absolute humidity inside the apparatus changes by a predetermined second threshold value.

5. The electrophotographic image forming apparatus according to claim 4, wherein the density sensor measures, each time the pattern formation section forms the density detection pattern, a density of the formed density detection pattern.

6. The electrophotographic image forming apparatus according to claim 1, wherein the control section sets a dither pattern density for binder toner among plural types of toners provided in the apparatus, based on the absolute humidity inside the apparatus derived by the absolute humidity derivation section.

7. An electrophotographic image forming apparatus comprising:
an absolute humidity derivation section which derives absolute humidity inside the apparatus; and
a control section which, when the absolute humidity inside the apparatus derived by the absolute humidity derivation section is larger than a predetermined first threshold value, sets the number of times a toner image is repeatedly transferred to a print target medium such that the number is larger as compared to when the absolute humidity inside the apparatus is smaller than the predetermined first threshold value.

8. The electrophotographic image forming apparatus according to claim 7, further comprising:
a temperature and humidity sensor which measures temperature and humidity inside the apparatus,
wherein the absolute humidity derivation section derives the absolute humidity based on the temperature and the humidity measured by the temperature and humidity sensor.

9. The electrophotographic image forming apparatus according to claim 7, further comprising:
a pattern formation section which image-forms a density detection pattern on a transfer belt; and
a density sensor which measures a density of the density detection pattern image-formed by the pattern formation section,
wherein the control section sets the number of times the toner image is repeatedly transferred to the print target medium, based on the density of the density detection pattern measured by the density sensor.

10. The electrophotographic image forming apparatus according to claim 9, wherein the pattern formation section changes time intervals at which the density detection pattern is image-formed each time the absolute humidity inside the apparatus changes by a predetermined second threshold value.

11. The electrophotographic image forming apparatus according to claim 10, wherein the density sensor measures, each time the pattern formation section forms the density detection pattern, a density of the formed density detection pattern.

12. The electrophotographic image forming apparatus according to claim 7, wherein the control section sets, for a toner image formed with binder toner among plural types of toners provided in the apparatus, the number of times the toner image is repeatedly transferred to the print target medium, based on the absolute humidity inside the apparatus derived by the absolute humidity derivation section.

13. A print sheet creation method using an electrophotography technology, comprising:
an absolute humidity derivation step of deriving absolute humidity inside an apparatus; and
a latent image formation step of, when the absolute humidity inside the apparatus derived in the absolute humidity derivation step is smaller than a predetermined first threshold value, setting a dither pattern density based on an original image to be smaller compared to when the absolute humidity inside the apparatus is larger than the predetermined first threshold value, and forming a latent image on a photosensitive drum.

14. The print sheet creation method according to claim 13, further comprising:
a transfer step of transferring a toner image such that, when the absolute humidity inside the apparatus derived in the absolute humidity derivation step is larger than a predetermined second threshold value, the number of times the toner image is repeatedly transferred to a print target medium is set to be larger as compared to than when the absolute humidity inside the apparatus is smaller than the predetermined second threshold value.

15. The print sheet creation method according to claim 14, further comprising:
a developing step of forming a toner image on the photosensitive drum by developing the latent image formed on the photosensitive drum in the latent image formation step by using toner,
wherein the transfer step includes transferring the toner image formed on the photosensitive drum in the developing step to the print target medium via a predetermined transfer belt.

16. The print sheet creation method according to claim 13, wherein the latent image formation step includes setting a dither pattern density for binder toner among plural types of toners based on the absolute humidity inside the apparatus derived in the absolute humidity derivation step.

17. The print sheet creation method according to claim 14, wherein the transfer step includes changing, for a toner image formed with binder toner among plural types of toners, the number of times the toner image is repeatedly transferred to the print target medium.

18. The print sheet creation method according to claim 17, wherein the transfer step includes transferring a toner image formed with color toner among the plural types of toners to the print target medium prior to transferring the toner image formed with the binder toner to the print target medium.

19. The print sheet creation method according to claim 13, further comprising:
a pattern formation step of image-forming a density detection pattern on a transfer belt; and
a density measurement step of measuring a density of the density detection pattern image-formed in the pattern formation step,
wherein the latent image formation step includes setting the dither pattern density based on the density of the density detection pattern measured in the density measurement step.

20. The print sheet creation method according to claim 14, further comprising:
a pattern formation step of image-forming a density detection pattern on a transfer belt; and
a density measurement step of measuring a density of the density detection pattern image-formed in the pattern formation step,
wherein the transfer step includes changing the number of times the toner image is repeatedly transferred to the print target medium based on the density of the density detection pattern measured in the density measurement step.
